(19) United States
(12) Patent Application Publication
(10) Pub. No.: US 2026/0277983 A1
(43) Pub. Date: Sep. 17, 2026

(54) HETEROGENOUS CONTENT COLLECTION PACKAGE COMPLIANCE TESTING PROCESSES

(71) Applicant: ComplyAuto IP LLC, Salt Lake City, UT (US)

(72) Inventors: Christopher James CLEVELAND, Sundance, UT (US); Casey Andrew GRAFF, Sandy, UT (US); David Wesley PODOLSKY, San Diego, CA (US)

(73) Assignee: ComplyAuto IP LLC, Salt Lake City, UT (US)

(21) Appl. No.: 19/673,742

(22) Filed: May 11, 2026

Related U.S. Application Data
(63) Continuation-in-part of application No. 19/279,984, filed on Jul. 24, 2025, now Pat. No. 12,645,956.
(60) Provisional application No. 63/676,120, filed on Jul. 26, 2024.

(51) Int. Cl. G06F 16/353; G06F 9/445

(52) U.S. Cl. CPC G06F 16/353; G06F 9/44505

(57) ABSTRACT

A method of compliance testing comprising receiving, a request to check compliance of a content collection package comprising a plurality of content items and a compliance ruleset, transmitting an instruction to classify the plurality of content items based on a classification ruleset, iteratively processing, the plurality of content items by identifying, a type of the given content item, a content item field set comprising each field on the given content item, and a content item field attribute set for each field in the field set, and accessing, from a structure profile database, a structure profile field set and a structure profile field attribute set for each field in the structure profile field set; iteratively processing each field in the structure profile field set for generating a compliance audit package and a compliance determination dataset models, and displaying an output on a user interface based on the compliance determination dataset.

### INCORPORATION BY REFERENCE

Any and all applications for which a foreign or domestic priority claim is identified in the Application Data Sheet as filed with the present application are hereby incorporated by reference under 37 CFR 1.57.

### BACKGROUND

Compliance testing for large collections of digital content presents a number of technical challenges. At scale, organizations need to ensure that each digital package—such as documents, images, audio, or video files—not only adheres to internal policies but also complies with external and often rapidly evolving regulatory requirements.

Content packages often carry content in inconsistent formats, and diverse file types. Reliably extracting content information is essential for automated compliance checks. The classifying the large datasets is a tedious task that can lead to errors, non-compliance or unnecessary delays. Accurately performing compliance check of content by identifying the relevant compliance rules for each item is a challenge, nonetheless. Regulations may differ by region, content type, or period, and rulesets might include combinations of explicit requirements, exceptions, and dependencies that complicate automated evaluation.

With the proliferation of new regulatory requirements and complex content collections, an optimal system and method for performing compliance check is needed to keep up with the rapidly evolving compliance standards.

### BRIEF SUMMARY

In various embodiments, a compliance testing system includes a non-transitory computer-readable storage medium storing instructions that, when executed by a computer, configure the computer to perform specific operations. These operations include receiving a request to check the compliance of a content collection package, which contains multiple content items and a compliance ruleset. The system may then transmit a first prompt to a first set of machine learning models, instructing them to classify the first portion of content items according to a classification ruleset.

The system may iteratively process each content item in content collection package with the machine learning models by identifying the type of the content item, identifying a content item fields set, and identifying attributes for each field in the content item fields set. For each content item, the system may access a structure profile from a structure profile database, which includes both a structure profile field set and a structure profile field attributes set for each field in the structure profile field set. The system compares the content item field set to the structure profile field set, and if a field from the structure profile field set is not present in the content item, the system may invoke a field absent routine. For each field in the structure profile field set, the system evaluates content item field attribute set against the constraints in the structure profile field attributes set.

If the content item field attribute set does not comply with the constraints in the structure profile field attributes set, the system may invoke an invalid field routine. If content item field attribute set contains a target information, the content item field and the content item field attribute set are extracted into a compliance audit package.

Using a second set of machine learning models, the system may conduct a compliance testing based on a set of compliance rules and the compliance audit package.

In another aspect, a method of conducting compliance testing comprises receiving a request to check compliance of a content collection package with a compliance ruleset, classifying the content items using a first set of machine learning models, and iteratively processing them to identify their type, fields, and field attributes. Structure profiles are accessed from a database to obtain field sets and associated attributes. Each structure profile field is compared to the corresponding fields and attributes on the content item, with missing or invalid fields triggering respective routines. If certain target information is detected, relevant data is extracted into a compliance audit package.

The method further includes generating a compliance determination dataset, using a second set of machine learning models, based on the compliance ruleset and the audit package, to indicate whether each compliance criterion is met. An output based on this dataset is displayed on a user interface.

Additional implementations of the disclosure are described below in reference to the appended claims, which may serve as an additional summary of the disclosure.

In various implementations, systems and/or computer systems are disclosed that comprise a computer-readable storage medium having program instructions embodied therewith, and one or more processors configured to execute the program instructions to cause the systems and/or computer systems to perform operations comprising one or more aspects of the above-and/or below-described implementations (including one or more aspects of the appended claims).

In various implementations, computer-implemented methods are disclosed in which, by one or more processors executing program instructions, one or more aspects of the above-and/or below-described implementations (including one or more aspects of the appended claims) are implemented and/or performed.

In various implementations, computer program products comprising a computer-readable storage medium are disclosed, wherein the computer-readable storage medium has program instructions embodied therewith, the program instructions executable by one or more processors to cause the one or more processors to perform operations comprising one or more aspects of the above-and/or below-described implementations (including one or more aspects of the appended claims).

Although certain embodiments and examples are disclosed herein, inventive subject matter extends beyond the examples in the specifically disclosed embodiments to other alternative embodiments and/or uses, and to modifications and equivalents thereof.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a flow chart depicting various steps involved in performing compliance check in accordance with one embodiment.

FIG. 2 illustrates a flow chart depicting a method of performing compliance check in accordance with one embodiment.

FIG. 3 illustrates a systematic workflow for content classification. in accordance with one embodiment.

FIG. 4 illustrates a process of field validation according to one embodiment.

FIG. 5 illustrates a process of field validation according to another embodiment.

FIG. 6 illustrates An exemplary content collection package for driver's license renewal in accordance with one embodiment.

FIG. 7 illustrates an exemplary structure profile database schema according to one embodiment.

### DETAILED DESCRIPTION

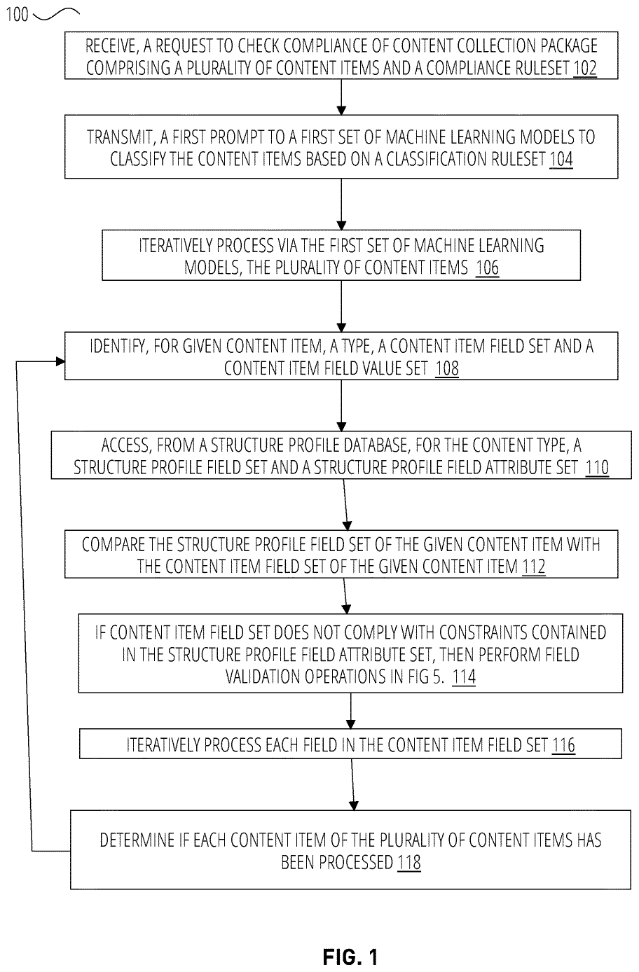

In one aspect, various steps depicting a process 100 of conducting compliance testing is shown in FIG. 1. At block 102, a request to check compliance of a content collection package is received. The request may include a plurality of content items and a compliance ruleset. The request may be submitted from users through user interfaces to efficiently perform compliance check utilizing one or more Large Language Models (“LLMs”). The disclosed system may conduct compliance testing very quickly, within seconds or minutes as compared to manual compliance check that may take days or months for compliance check completion. Additionally, the system may periodically perform compliance checks on content items following a set schedule. Further, the system may perform compliance checks in response to occurrence of specific events (e.g., regulatory changes). Furthermore, the system may proactively discover and identify relevant content items by searching web pages, and conducting compliance assessments on the identified items.

The accuracy of these automated compliance checks can be maintained at a level comparable to manual checks by professionals (e.g., compliance experts or attorneys), by incorporating detailed instructions in prompts to the LLMs and employing automated validation and correction techniques for LLM outputs. By leveraging the systems and methods described herein, LLMs can efficiently and accurately perform compliance checks on large sets of rules and content items, significantly reducing errors and enhancing the reliability of compliance results.

To process the request, the system may transmit at block 104, via a content item classifier, a first prompt to a first set of machine learning models. The first prompt may include an instruction to classify the plurality of content items based on a classification ruleset. As the name suggests, the classification ruleset comprises a set of rules for classifying a plurality of content items of various types. The compliance testing may be requested for a variety of content item types, such as textual content item, visual content items, audio content items, video content items, or any combination thereof.

Similarly, the content item may be stored in various electronic data file formats (e.g., Portable Document Format (PDF), WORD file, JPEG, GIF, or other data file formats). The content item may be an image that includes both representations of objects (e.g., picture of a car and a tree, image of system components, representative thumbnail of media, etc.) and images of textual description of a car and a tree. In some cases, a single compliance request may contain multiple content collection packages, each content collection package containing several content items in various formats.

The disclosed system, at block 104 may transmit, a first prompt to a first set of machine learning models to classify the content items based on a classification ruleset. The classification ruleset may be identified based on the received compliance ruleset, and may contain configuration parameters for configuring the first set of machine learning models.

The first set of machine learning models may, at block 106, perform the actions indicated in blocks 108-118 below to process each content item in the content collection package received at block 102. In one embodiment, the first set of machine learning models may, sequentially process each content item received in the content collection package. In this embodiment, the first set of machine learning models may process content items received in the content collection package in the order it was received by the system. In another embodiment, the first set of machine learning models may process the content items from the content collection package based on a predefined order of priority, defined by a user or a regulatory authority. In yet another embodiment, the first set of machine learning models may process the content items from the content collection package based on a random order.

The first set of machine learning models may, at block 106, iteratively process the plurality of content items in the content collection package. Via iterative process, the system may continue to process a content item in the content collection package until each content item in the content collection package is processed. At block 108 the first set of machine learning models may identify, a type of the given content item, a content item field set comprising each field included in the given content item, and a content item field attribute set or content item field value set, indicating an attribute or value for each field in the content item field set.

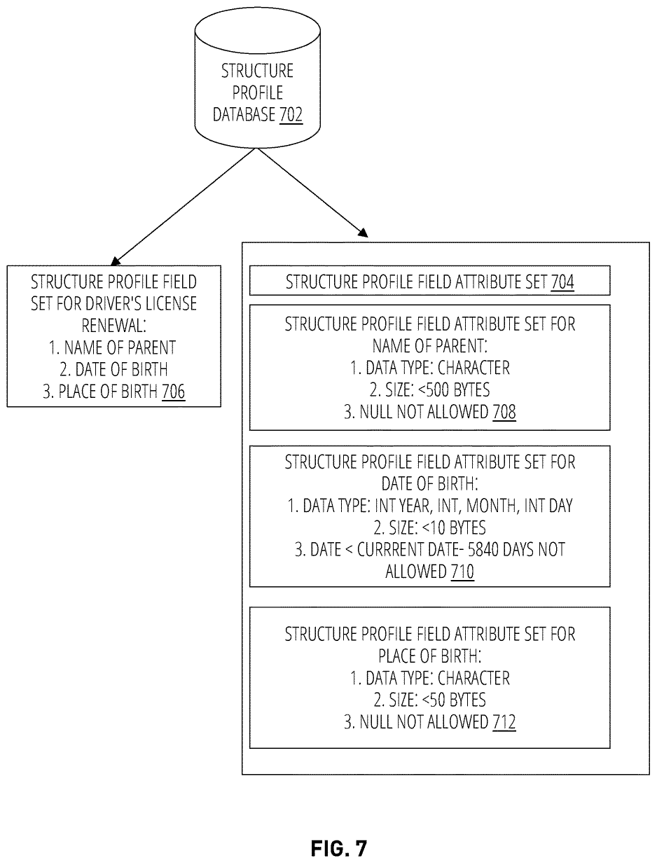

The system may for instance, determine at block 108, that the type of received content item is a text document, and that the given text document is a birth certificate. To ensure that all of the fields that are expected to appear in the birth certificate document are in fact present in the given birth certificate, the disclosed system at block 110, may access, a structured profile database shown in FIG. 7, to identify a structure profile for the given content item, i.e., a birth certificate.

The system may access, at block 110, from a structure profile database, a structure profile field set and a structure profile field attribute set for the given content item, based on the type of the given content item that was identified at block 108. For each content type, the structure profile database may include, a structure profile field set and a structure profile field attribute set. The system may, at block 112, compare the structure profile field set of the given content item i.e., birth certificate, with the content item field set of the given item.

The disclosed system may extract from the structure profile database, a structure profile field set for the birth certificate content item. The structure profile field set may include a list of three fields that are expected to be present on the birth certificate. It is observed that at this point the system is not concerned about the content of the fields appearing on the birth certificate, but the system is focused on ensuring that each field that is expected to appear in the birth certificate is in fact present in the given birth certificate. In other words, the structure profile field set may be used to verify that the given content item has each required field that is expected to be present on the given type of content item.

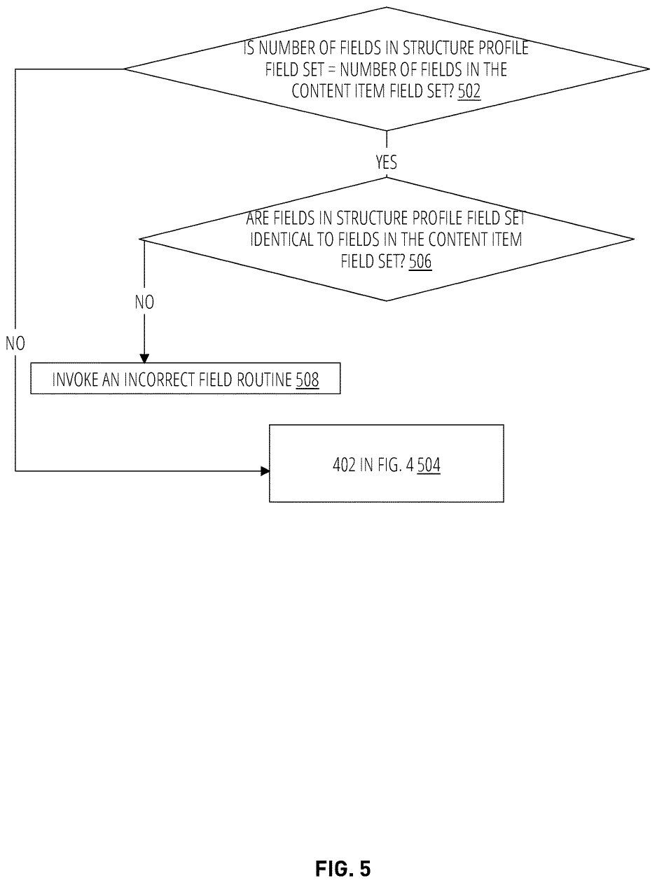

If at block 112, the system determines that the content item field set for the birth certificate is not identical to the structure profile field set for the birth certificate, the system may invoke an incorrect field routine discussed in FIG. 5. Conversely, if the content item field set for the birth certificate is identical to the structure profile field set for the birth certificate, indicating that the structure profile field set for the given content item has all of the required fields that are expected to be present on the given type of content item, the system may proceed to block 114 to evaluate if the contents of a given field of the content item field set complies with the constraints in the structure profile field attribute set for the given field.

The structure profile field attribute set for the given field may include a list of constraints for the given field. The system may determine if the contents/value of a given field complies with the constraints in the structure profile field attribute set for the given field. If the disclosed system at block 114 determines that the value of the given field does not comply with the constraints contained in the structure profile field attribute set for the given field, system may then perform field validation operations illustrated in FIG. 5.

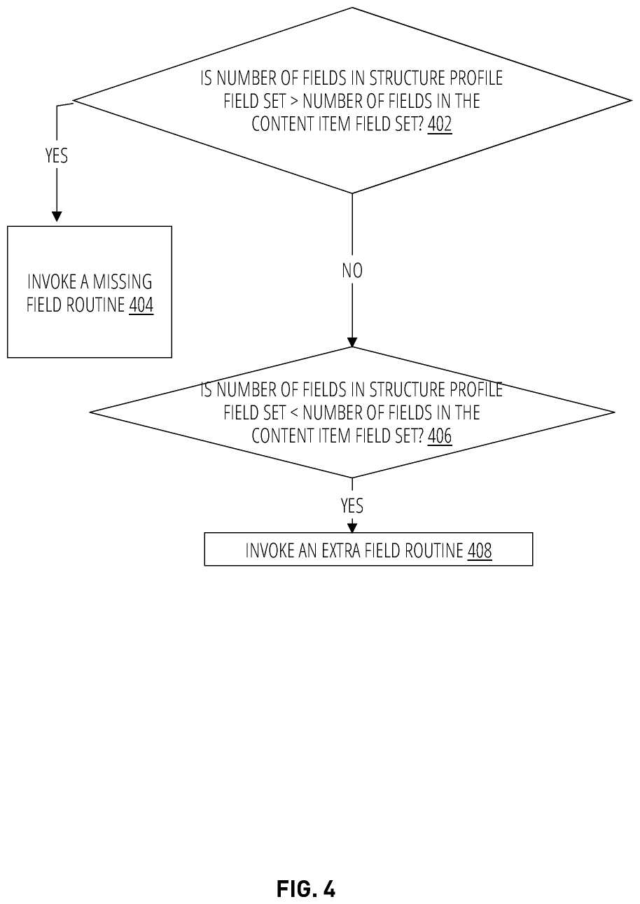

In other words, if the content item field set for birth certificate is not identical to the structure profile field set for the birth certificate, or if the content item field attribute set for the given field does not comply with the constraint indicated in the structure profile field attribute set for the given field, the system may manage that infirmity in a number of ways as discussed later in conjunction with FIGS. 4 and 5.

The system may, at block 116, iteratively process each field in the content item field set to determine if a given field complies with the first constraint included in the structure profile field attribute set for the given field. In the next iteration, the system may determine if the given field complies with the second constraint included in the structure profile field attribute set for the given field. In this manner, by iteratively processing each constraint from the structure profile field attribute set, the system may validate given field, by ensuring that given value of the given field satisfies each limitation from the structure profile field attribute set for the given field. Upon confirming that each field in the content item field set complies with the constraints included in the structure profile field attribute set for the given field, the system may proceed to block 118. At block 118, the system may determine if each content item of the plurality of content items has been processed.

For example, the birth certificate may have a first field “a name of the parent”. After processing the first field, the name of the parent, the disclosed system may also process the second and the third content items i.e., the date of birth, and the place of birth, respectively, via the iterative processing indicated in blocks 108 through 118.

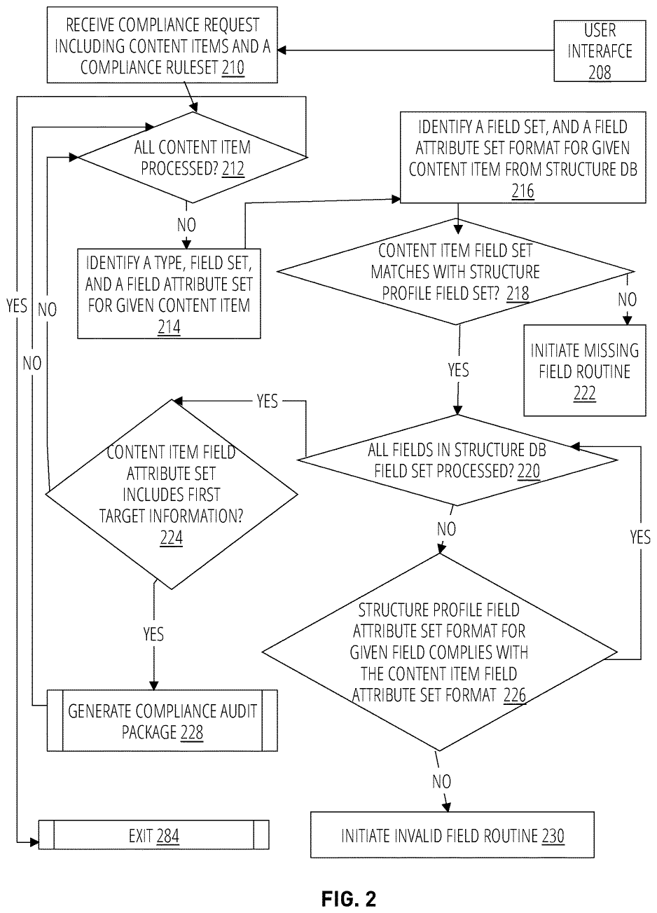

Now turning to FIG. 2, illustrating an example routine for compliance testing. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

The process begins at block 208 when a request to perform compliance testing is presented from a user interface. At block 210, the system may receive the compliance testing request comprising a content collection package comprising several content items and a compliance ruleset. The system is expected to check if the content items comply with the rules contained in the compliance ruleset.

The compliance ruleset may contain different sets of rules for determining whether one or more content items of the content collection package comply with one or more type of regulations, such as a government regulation, finance regulations, insurance regulations, and the like. For example, the compliance ruleset may include any type of ruleset to determine compliance of a content item with a set of criteria, such as a color scheme, a composition of content, an agreement between parties, a user preference, or any other type of criteria that can be used to evaluate content.

At block 212 the system may determine whether all of the content items in the content collection package have been processed. The system may iteratively process content items by identifying a type, a content item field set, and a content item attribute set for a given content item, until each content item from the content collection package is processed.

As discussed above, via iterative processing, the first content item is processed first and then the system moves on to processing the next content item, this loop is repeated until every single content item in the content collection package is processed. After identifying the type of content item, the content item field set and a content item field attribute set for the given content item at block 214, the system may access a structure profile field set, and a structure for profile field attribute set, for the given content item from the structure database at block 216.

The system may at block 218 determine whether the content item field set matches with the structure profile field set, if the content item field set does not match with the structure profile field set, then the system may proceed to block 222 to initiate a missing field routine. Otherwise, if the content item field set matches with the structure profile field set, the system may proceed to block 220 to determine whether all of the fields in the structured database field set have been processed.

Upon determining that all of the fields in the structured database field set have been processed, the system may move on to block 224 to evaluate whether the content item field attribute set includes the first target information. On the other hand, if the system determines at block 220 that all of the fields in the structured database field set have not been processed, then the system may go on to block 226 to determine whether the structure profile field attribute set format for the given field complies with the content item field attribute set format at block 226.

In one embodiment the content item field attribute set may indicate a value associated with the given field from the content item field set. In this embodiment, the structure profile field attribute set may indicate constraints on the given field. For example, if the system is processing from the content item field set, a given field called a name field, and if the content item field attribute set includes a value “Jane Doe” for the name field, then the system may compare, the value for the given field, from the content item field attribute set with the constraints in the structure profile field attribute set for the given field.

For example, the structure profile field attribute set for the given field “name of the parent” may indicate that the given field name be of character data type and be stored in less than 500 bytes. If both of these conditions are met, namely if the value “Joe Doe” is of character data type, and is stored in less than 500 bytes, then the system concludes that the content item field attribute complies with the structure profile field attribute.

If the content item field attribute format for the given field does not comply with the constraints in the structure profile field attribute set for the given field, then the system may move on to block 230 to initiate an invalid field routine. On the other hand, if the content item field attribute format for the given field complies with the constraints in the structure profile field attribute set for the given field, then the system goes back to block 220 to determine if all of the fields in the structured database have been processed.

Once all of the fields in the structured database have been processed, the system may move on to block 224 to determine whether content item field attribute set includes a first target information.

Upon determining at block 224 that the content item field attribute set includes the first target information, the system may move on to block 228 to generate a compliance audit package by extracting the given field from the content item field set and the content item field attribute set associated with the given field into a compliance audit package.

After generating compliance audit package at block 228, the system may proceed back to block 212 to determine if all of the content items from the content collection package have been processed. If the system at block 212 determines that all of the content items from the content collection package have been processed, then the system may exit at block 284. Conversely, if the system notices that all of the content items from the content collection package have not been processed then the system may repeat the steps indicated in blocks 214 through 228 to process the remaining unprocessed content items.

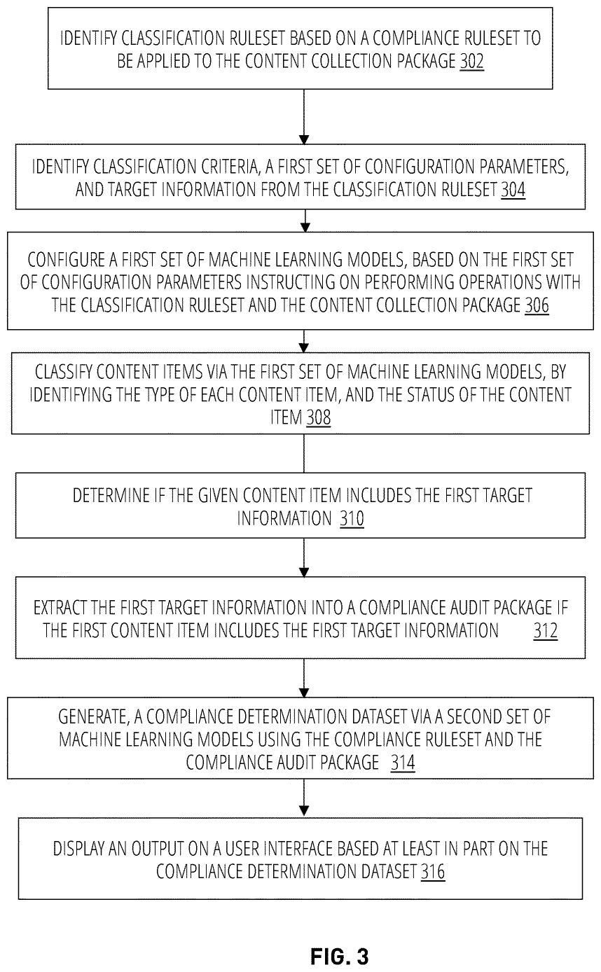

Referring now to FIG. 3, illustrating a systematic workflow for content classification. The process begins at block 302 with the system identifying a classification ruleset for classifying the content items in the content collection package. The specific classification ruleset may be identified from a plurality of classification rulesets that may be stored in a compliance ruleset data store. The classification ruleset may be identified based on a content compliance ruleset to be applied to the content collection package. The content compliance ruleset may be identified based on input from a user interface as discussed above in conjunction with FIG. 1.

The system may identify a classification criteria, a first set of configuration parameters, and a target information from the classification ruleset at block 304. In embodiments, the classification ruleset may provide a first set of configuration parameters for configuring a first set of machine learning models. In particular, the first set of configuration parameters may specify a set of instructions for the first set of machine learning models on performing operations with respect to the classification ruleset and the content collection package. Accordingly at block 306, the system may configure the first set of machine learning models based on the configuration parameters, instructing on performing operations with respect to the classification ruleset and the content collection package.

At block 308, the system may classify content items via the first set of machine learning models, by identifying the type of each content item, and the status of the content item. The system may determine if the given content item includes the first target information at block 310 before extracting the first target information into a compliance audit package if the given content item includes the first target information at block 312.

The system may generate, a compliance determination dataset at block 314 via a second set of machine learning models using the compliance ruleset and the compliance audit package. The system may ultimately display, at block 316, an output on a user interface based at least in part on the compliance determination dataset.

Referring now to FIG. 4, indicating a process of field validation according to one embodiment. The system may identify the number of fields in the content item field set. Further, the system may access the structure profile database, to count the number of fields in structure profile field set. The system may compare the number of fields in structure profile field set and the number of fields in the content item field set. The system may, at block 402, determine if the number of fields in structure profile field set is greater than the number of fields in the content item field set.

Having a greater number of fields in the structure profile field set than the number of fields in the content item field set, may indicate that at least one field that is expected to be on the given content item is not present on the given content item. Thus, if the number of fields in structure profile field set is greater than the number of fields in the content item field set, the system may invoke, at block 404 a missing field routine. The system may indicate to the user about the missing field and may resume the compliance check once the missing field and a value associated therewith is provided by the user.

If the number of fields in structure profile field set is not greater than the number of fields in the content item field set, that indicates that each field from the structure profile field set is present in the content item field set, in that event, the system may proceed to block 406, to determine if the number of fields in the content item field set is greater than the number of fields in the structure profile field set.

Having a greater number of fields in the content item field set than the number of fields in the structure profile field set may indicate that at least one field that is not expected to be on the given content item is present on the given content item. Thus, if the number of fields in the content item field set is greater than the number of fields in the structure profile field set, the system may invoke, at block 408 an extra field routine. The system may indicate to the user about the extra field and may resume the compliance check one the extra field and a value associated therewith is deleted by the user.

As shown in FIG. 5, if the system may at block 502, determine if same number of fields are present on the structure profile field set and the content item field set. If the system observes that same number of fields are not present on the structure profile field set and the content item field set, the system may proceed to block 402 of FIG. 4. Turning back to FIG. 5, alternatively, if the system observes that same number of fields are present on the structure profile field set and the content item field set, the system may conclude that same number of fields are present on both the structure profile field set and the content item field set. Next the system may proceed to reviewing the contents of each the fields in the structure profile field set and the content item field set to make sure that identical fields are contained in the structure profile field set and the content item field set.

To that end, as shown in FIG. 5, the system may, at block 506, determine if the fields in structure profile field set are identical to the fields in the content item field set. The system may, resume normal processing if the fields in structure profile field set are identical to the fields in the content item field set. In contrast, if the fields in structure profile field set are not identical to the fields in the content item field set, the system may invoke an incorrect field routine at block 508. The system may identify missing fields, mismatching fields, and extra fields before prompting the user to provide a rectified content item.

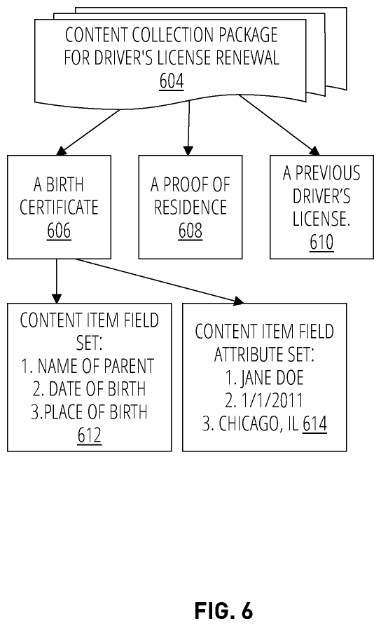

An exemplary content collection package for driver's license renewal is illustrated in FIG. 6. The content collection package 604 may include several documents that are compiled together for a specific purpose. A content collection package for driver's license renewal 604 may include a collection of content items that are useful in driver's license renewal. For instance, the content collection package for driver's license renewal 604 may contain three documents: a birth certificate 606, a proof of residence 608, and a previous driver's license 610. The system may iteratively process three documents the birth certificate 606, the proof of residence 608, and the previous driver's license 610 from the content collection package for driver's license renewal 604.

Specifically, the system may process a first content item 606 from the content collection package 604. The system may identify a type of the first content item as a birth certificate, and extract a content item field set 612 from the content collection package for driver's license renewal 604. The content item field set 612 may include three fields, as shown in FIG. 6, the first field may indicate the name of the parent of the person seeking to renew her driver's license, the second and the third fields may comprise the date of birth, and the place of birth, of the person seeking to renew her driver's license, respectively. Similarly, the system may also extract a content item field attribute set 614 from the content collection package 604. The content item field attribute set 614 may include a value for the name of the parent field as “Jane Doe”, a value for the date of birth field as “Jan. 1, 2011”, value for the place of birth field “Chicago, IL” as shown in FIG. 6.

FIG. 7 illustrates an exemplary structure profile database schema according to one embodiment. The disclosed system may extract from the structure profile database, a structure profile field set 706 for the birth certificate content item. The structure profile field set 706 may include a list of three fields that are expected to be present on the birth certificate. As shown in FIG. 7, the structure profile field set 706 for the birth certificate content item thus may comprise three fields: name of the parent of the parent of the person seeking to renew her driver's license, date of birth, and place of birth of the parent of the person seeking to renew her driver's license.

Additionally, the disclosed system may access, from the structure profile database 702, a structure profile field attribute set 704 for the given content item i.e. a birth certificate. The structure profile field set 704 may include a list of constraints for each field in the structure profile field set 706. It is observed that at this point the system is not concerned about the content of the fields appearing on the birth certificate, but the system is focused on ensuring that each field that is expected to appear in the birth certificate in a specific format, is in fact present in the given birth certificate in the expected format.

To that end, the system may, compare the structure profile field set 706 of the given content item i.e., birth certificate, (comprising three fields) with the content item field set of the birth certificate (also comprising three fields). The disclosed system may then compare the structure profile field set 704 of the given field with the content item field set of the given content item.

Additionally, the disclosed system may, access a structure profile field attribute set 704 for the birth certificate content item. The structure profile field set 704 may include a list of constraints for each field in the structure profile field set 706.

Along with the structure profile field set, the structure profile database 702 may also include a structure profile field attribute set 704 for each field in the structure profile field set 706. The system may validate the content item field attribute set 614 of the given field, against the structure profile field attribute set 704 of the given content item, the birth certificate. It should be appreciated that even though three attributes such as a data type, a size, a constraint are shown in FIG. 7, for each field in the structured profile field set, a given field may have additional or fewer field attributes in the structure profile field attribute set 704.

In one embodiment, the content item field value set may indicate a value associated with a given field from the content item field set. For example, as shown in FIG. 6, the name of the parent field from the content item field set 612 may have a value of Jane Doe, as shown in the content item field attribute set 614, which may represent the name of the parent of the person seeking to renew her driver's license.

In this embodiment, the structure profile field attribute set may impose a limitation on the value, by specifying attributes of acceptable input for the name of the parent. For instance, the structure profile field attribute set 704 may have three constraints on the “name of the parent” field of the birth certificate. A first constraint on the “name of the parent” field, may mandate that a character data type be associated with the name of the parent field. In other words, the name of the parent is expected to be in the character format. Additionally, structure profile field attribute set 704 may impose a limitation on the size of the name of the parent field, for example, profile field attribute set 704 may specify that the size of the name of the parent should be less than 500 bytes. Yet another constraint for the name of the parent field may be that the name of the parent cannot be left blank. Still another constraint may require that the parent's first name, the middle initial and the last name must be separated by a blank space. Similar constraints may also be imposed on the date of birth fields and place of birth fields as shown in FIG. 7.

What is claimed is:

1. A compliance testing system comprising a non-transitory computer-readable storage medium, the computer-readable storage medium including instructions that when executed by a computer, cause the computer to:
receive, a request to check compliance of a content collection package comprising a plurality of content items and a compliance ruleset;
transmit, via a content item classifier, a first prompt to a first set of machine learning models, the first prompt comprising an instruction to classify the plurality of content items based on a classification ruleset;
iteratively process, via the first set of machine learning models, each content item of the plurality of content items to:
identify a type of given content item;
identify a content item field set comprising each field on the given content item;
identify a content item field attribute set for each field in the content item field set;
access a structure profile for the given content item from a structure profile database, the structure profile comprising, a structure profile field set and a structure profile field attribute set for each field in the structure profile field set;
compare, the structure profile field set with the content item field set;
initiate a field absent routine if a given field from the structure profile field set is not in the content item field set;
iteratively process a given field in the structure profile field set to:
compare, the structure profile field attribute set of the given field with the content item field attribute set of the given field;
initiate a missing field routine if the structure profile field set of the given field does not match with the content item field set associated of given field;
initiate an invalid field routine if the structure profile field attribute set of the given field does not match with the content item field attribute set of the given field;
extract the given field from the content item field set and the content item field attribute set of the given field into a compliance audit package, if the content item field attribute set for the given field contains a first target information;
conduct compliance checking via a second set of machine learning models based on a set of compliance rules and the compliance audit package; and
conduct compliance checking via a compliance checker using the compliance determination dataset.

2. The compliance testing system of claim 1, wherein the classification ruleset comprises, a first set of configuration parameters for configuring a first set of machine learning models, wherein the first set of configuration parameters comprising a set of instructions on operations to perform on the content collection package.

3. The compliance testing system of claim 2, wherein the structure profile database comprises a structure profile field set and a structure profile field attribute set.

4. The compliance testing system of claim 1, wherein, the request to check compliance of the content collection package is at least identified, uploaded, or generated via the user interface.

5. The compliance testing system of claim 1, wherein, the request to check compliance of the content collection package is, at least triggered by a triggering event or by passage of time.

6. The compliance testing system of claim 1, the request to check compliance of a content collection package is initiated by at least one of a user interface, an occurrence of an event, a website access, or passage of a time integral.

7. The compliance testing system of claim 1, wherein the content items format is at least one of a text, an image, an audio, a video, or other media content.

8. The compliance testing system of claim 1, wherein the content items comprise a text format and an image format.

9. The compliance testing system of claim 8, wherein the content items are stored in a Portable Document Format file, a Microsoft word file, a Joint Photographic Experts Group file, a Graphics Interchange Format file, or other similar electronic data file formats.

10. The compliance testing system of claim 1, wherein the content items comprise an image that includes both representations of objects and images of text.

11. A method of compliance testing comprising:
receiving, a request to check compliance of a content collection package comprising a plurality of content items and a compliance ruleset;
transmitting, via a content item classifier, a first prompt to a first set of machine learning models comprising an instruction to classify the plurality of content items based on a classification ruleset;
iteratively processing, via the first set of machine learning models, the plurality of content items by:
identifying, a type of the given content item, a content item field set comprising each field on the given content item, and a content item field attribute set for each field in the field set;
accessing, from a structure profile database, a structure profile field set and a structure profile field attribute set for each field in the structure profile field set;
iteratively processing each field in the structure profile field set by:
comparing, the structure profile field attribute set of the given field with the content item field attribute set of the given field;
initiating a missing field routine if the structure profile field set of the given field does not match with the content item field set of the given field;
initiating an invalid field routine if the structure profile field attribute set of the given field does not match with the content item field attribute set of the given field;
extracting the content item field set and the content item field attribute set for the given field into a compliance audit package, if the content item field attribute set for the given field contains a first target information;
generating, based on the compliance ruleset and the compliance audit package, a compliance determination dataset indicating whether the compliance package meets each compliance ruleset criteria, via a second set of machine learning models; and
displaying an output on a user interface based at least in part on the compliance determination dataset.

12. The compliance testing method of claim 11, wherein the classification ruleset comprises a document type, a document identifier, a document content indicator, and a set of expected content items for each document in a set of documents.

13. The compliance testing method of claim 11, wherein the classification ruleset comprises a document type, a document identifier, a document content indicator, and a set of expected content items for each document in a set of documents.

14. The compliance testing method of claim 11, wherein the structure profile database comprises for a set of document types, and a set of identifying features identifying the document.

15. The compliance testing method of claim 11, wherein the first set of machine learning models identifies the type of the given content item based on the set of identifying features comprising a document header, a document identifier, and a type of information contained in the document.

16. The compliance testing method of claim 11, wherein the type of information contained in the document comprises a pricing information, a privacy information, a banking information, a financing information, and the like.

17. The compliance testing method of claim 11, is further configured to group, via a content item classifier, the plurality of portions of the content items that are part of the same content item.
